(19) United States
(12) Patent Application Publication
(10) Pub. No.: US 2008/0017469 A1
(43) Pub. Date: Jan. 24, 2008

(54) AUTOMATIC TRANSMISSION

(75) Inventors: Tatsuhiko Iwasaki, Hiroshima (JP); Junichi Doi, Hiroshima (JP); Tatsutoshi Mizobe, Hiroshima (JP); Naohiro Sakaue, Hiroshima (JP)

Correspondence Address: BROOKS KUSHMAN P.C., 1000 TOWN CENTER, TWENTY-SECOND FLOOR, SOUTHFIELD, MI, 48075, US

(73) Assignee: MAZDA MOTOR CORPORATION, Hiroshima (JP)

(21) Appl. No.: 11/775,570

(22) Filed: Jul. 10, 2007

(30) Foreign Application Priority Data
Jul. 24, 2006 (JP) 2006-200380
Aug. 2, 2006 (JP) 2006-210622

(51) Int. Cl. F16D 47/02; F16D 11/00; F16D 19/00

(52) U.S. Cl. 192/48.5; 192/85 R; 74/473.37

(57) ABSTRACT

A hub and a drum are respectively provided inside and outside a forward clutch (multiple-disc clutch) of an automatic transmission for a vehicle. A piston for pushing the forward clutch and a hydraulic servo for controlling the piston are provided inside the hub. A plurality of notched portions are formed in the piston and the hub with the positions thereof displaced from each other in the peripheral direction so that the piston and the hub are overlapped with each other in the axial direction in such a fashion that parts of one of the piston and the hub where no notched portions are formed are inserted into the notched portions of the other.

### CROSS REFERENCE TO RELATED APPLICATIONS

This Non-provisional application claims priority under 35 U.S.C. § 119(a) on Patent Applications No. 2006-200380 and No. 2006-210622 filed in Japan on Jul. 24, and Aug. 2, 2006, respectively, the entire contents of which are hereby incorporated by reference.

### BACKGROUND OF THE INVENTION

1. Field of the Invention

The present invention relates to an automatic transmission for a vehicle, and particularly relates to a technology for size reduction thereof.

2. Description of the Related Art

Conventionally, an automatic transmission has been known which includes a drum connected to the input shaft of the transmission, a hub connected to the output section thereof, and a multiple-disc clutch that connects/disconnect the drum from the hub.

An automatic transmission disclosed in, for example, Japanese Patent Application Laid Open Publication No. 2003-106342 includes a multiple-disc clutch, a hub provided inside the multiple-disc clutch, a drum provided outside the multiple-disc clutch, a piston for pushing the multiple-disc clutch, and a hydraulic servo for controlling the piston. The servo is provided at the drum in general.

Referring to another automatic transmission disclosed in Japanese Patent Application Laid Open Publication No. 2003-106450, there are provided a multiple-disc clutch, a hub for supporting at the outer periphery thereof the multiple-disc clutch, a drum for supporting at the inner periphery thereof the multiple-disc clutch, a piston for pushing the multiple-disc clutch, a hydraulic servo provided at the drum for controlling the piston, a rotation sensor for detecting the rotation of the hub, and an input side rotation speed sensor for detecting the rotation speed of an input side rotation element (an input shaft), wherein the input side rotation speed sensor detects the number of rotation of an outer peripheral part of the drum.

In recent years, demand for higher power of engines is increasing while there are another demand for size reduction of automatic transmissions accompanied by restriction on vehicle size.

In the vicinity of the multiple-disc clutch of the conventional automatic transmission, however, since difference in number of rotation between the hub connected to the output section and the piston provided at the drum connected to the input shaft of the transmission will be caused by connection/disconnection therebetween by the multiple-disc clutch. This requires creation of clearance to some extent between the hub and the piston, which inhibits overlap between the hub and the piston in the axial direction of the input shaft to prevent the automatic transmission from being compacted sufficiently.

While, when the hydraulic servo is provided at the hub connected to the input shaft, rather than the drum connected to the output section and the hub is overlapped with the piston in the axial direction, the number of rotation of the hub cannot be detected in the automatic transmission of Japanese Patent Application Laid Open Publication No. 2003-106342 because the hub is arranged inside the drum to be covered with the drum. Accordingly, the number of rotation of the input shaft must be measured directly. When doing so, however, detection accuracy becomes worse because of a small diameter of the input shaft at which the rotation is to be detected. Further, difficulty in ensuring space for the input side rotation speed sensor is involved.

### SUMMARY OF THE INVENTION

The present invention has been made in view of the foregoing and has its first object of reducing the size of an automatic transmission by overlapping a piston with a hub in an axial direction.

The second object of the present invention is to enable measurement of the number of rotation of the hub by a rotation sensor provided at the exterior of the drum with the automatic transmission reduced in size.

To attain the first object, in the present invention, the hydraulic servo is provided at the hub connected to the input shaft rather than at the drum connected to the output section.

Specifically, a first aspect of the present invention provides an automatic transmission including: an input shaft; an output section; a first rotary member connected to the input shaft; a second rotary member connected to the output section; a multiple-disc clutch that connects/disconnects the first rotary member to/from the second rotary member; a hub provided inside the multiple-disc clutch; a drum provided around the multiple-disc clutch; a piston which pushes the multiple-disc clutch; and a hydraulic servo that controls the piston, the hydraulic servo being provided at the hub or a member connected to the hub, wherein a plurality of notched portions are formed in the piston and the hub with positions thereof displaced from each other in a peripheral direction, and the piston and the hub are overlapped with each other in an axial direction in such a fashion that parts of one of the piston and the hub where no notched portions are formed are inserted into the notched portions of the other.

With the above arrangement, the hydraulic servo is provided at the hub connected to the input shaft or the member connected to the hub so that the piston and the hub rotate integrally with each other. This eliminates the need to create clearance for contact prevention therebetween. When the plurality of notched portions are formed in both the piston and the hub with the positions thereof displaced with each other in the peripheral direction, insertion of parts of the hub where no notched portions are formed into the notched portions of the piston results in overlap between the piston and the hub in the axial direction. Hence, the length in the axial direction of the automatic transmission can be reduced, thereby reducing the size as a whole.

In a second aspect of the present invention, the above automatic transmission further includes: a transmission casing surrounding the automatic transmission and including a transmission casing side wall; and a boss which extends in the axial direction from an axial center of the transmission casing side wall and through which the input shaft is inserted, wherein the first rotary member includes: the hub; a sleeve rotatably fitted to the boss; and a first annular portion connecting the hub and the sleeve.

With the above arrangement, the hub is connected by the first annular portion to the sleeve rotatably fitted to the boss extending from the transmission casing, so that pressurized operation oil can be supplied from the boss to the hydraulic servo. This eliminates the need to provide an additional high-pressure oil supply path, thereby shortening the length in the axial direction of the automatic transmission to reduce the size as a whole.

Referring to a third aspect of the present invention, in the above automatic transmission, the piston includes: a second annular portion having an inner peripheral part sliding on an outer periphery of the sleeve and extending radially outwardly; a cylindrical portion connected to an outer periphery of the second annular portion and extending toward the transmission casing side wall; and a third annular portion connected to an end part on the transmission casing side wall side of the cylindrical portion and extending in a radial direction.

The above arrangement reduces the piston in size, so that the piston is easily arranged at the hub or the member connected to the hub. Hence, the length in the axial direction of the automatic transmission is shortened to achieve size reduction as a whole.

Referring to a fourth aspect of the present invention, the above automatic transmission further includes a sealing plate which includes an inner peripheral part caught immovably toward the transmission casing side wall by the outer periphery of the sleeve and which extends radially outwardly so as to slide at an outer periphery thereof on an inner periphery of the cylindrical portion, wherein the piston forms a pressure chamber in a region surrounded by the sleeve, the second annular portion, the cylindrical portion, and the sealing plate.

With the above arrangement, the pressure chamber is formed inside the hub to reduce the hydraulic servo in size. This shortens the length in the axial direction of the automatic transmission, resulting in size reduction as a whole.

In a fifth aspect of the present invention, the hub includes a fourth annular portion cylindrically extending toward the transmission casing side wall, the second annular portion includes an outer peripheral part sliding on an inner peripheral face of the fourth annular portion, and the piston forms a balancing chamber in a region surrounded by the sleeve, the first annular portion, the fourth annular portion, and the second annular portion.

With the above arrangement, the sealing plate of the balancing chamber can be used as a connecting member between the hub and the sleeve, thereby achieving reduction in size of the hydraulic servo. Accordingly, the length in the axial direction of the automatic transmission is shortened, resulting in size reduction as a whole.

In a sixth aspect of the present invention, an operation oil supply guide is formed in the first annular portion for supplying operation oil to the hub from an opposite side of the first annular portion to the piston.

With the above arrangement, though the operation oil must be supplied to the hub from the opposite side of the piston because the piston is arranged inside the hub, the operation oil can be supplied to the hub therefrom along the operation oil supply guide formed in the first annular portion. This eliminates the need to provide an additional operation oil supply path, shortening the length in the axial direction of the automatic transmission to reduce the size as a whole.

To attain the second object of the present invention, a seventh aspect of the present invention provides a rotation sensor at the exterior of the drum and a to-be-detected part at which rotation sensor detects the rotation is set at the piston.

Specifically, the above automatic transmission further includes: a rotation sensor which detects rotation of the hub, the rotation sensor being provided at an exterior of the drum, wherein the piston and the hydraulic servo are provided at the hub or a member connected to the hub, and a to-be-detected part at which the rotation sensor detects the rotation thereof is provided at the piston.

With the above arrangement, the hub is provided inside the drum to be covered with the drum, thereby disabling direct detection of the number of rotation of the hub. On the other hand, the piston and the hydraulic servo are provided at the hub connected to the input shaft or the member connected to the hub so that the piston and the hub rotate integrally with each other. When the to-be-detected part where the rotation of the hub is detected is set at the piston, the number of rotation of the hub can be detected by the rotation sensor provided at the exterior of the drum through detection of the rotation of the piston. Further, the piston provided at the hub or the member connected to the hub can be utilized effectively for detecting the number of rotation of the hub, leading to space saving.

In an eighth aspect of the present invention, the to-be-detected part for the rotation sensor extends radially from an outer peripheral end of the piston on a side open to the drum and further extends in the axial direction between the rotation sensor and the drum.

With the above arrangement, the to-be-detected part for the rotation sensor extends from the outer peripheral end of the piston so as to cover the drum and is located between the drum and the rotation sensor, so that the rotation sensor, which is arranged at the same position as that of the conventional case though, can detect the number of rotation of the hub. Further, effective utilization of the piston for rotation detection achieves size reduction of the to-be-detected part.

### BRIEF DESCRIPTION OF THE DRAWINGS

FIG. 1 is a schematic diagram showing a whole construction of an automatic transmission in accordance with an embodiment of the present invention.

FIG. 2 is a sectional view in an enlarged scale showing a forward clutch and the vicinity thereof.

FIG. 3 is a perspective view showing the forward clutch and the vicinity thereof.

FIG. 4 is a perspective view showing hub side clutch discs to which a hub is fitted.

FIG. 5 is a perspective view showing drum side clutch discs to which a drum is fitted.

FIG. 6 is a perspective view of the hub as viewed from a transmission casing side wall.

FIG. 7 is a perspective view of a piston as viewed from the opposite side to the transmission casing side wall.

### DESCRIPTION OF THE PREFERRED EMBODIMENT

One embodiment of the present invention will be described below with reference to the accompanying drawings.

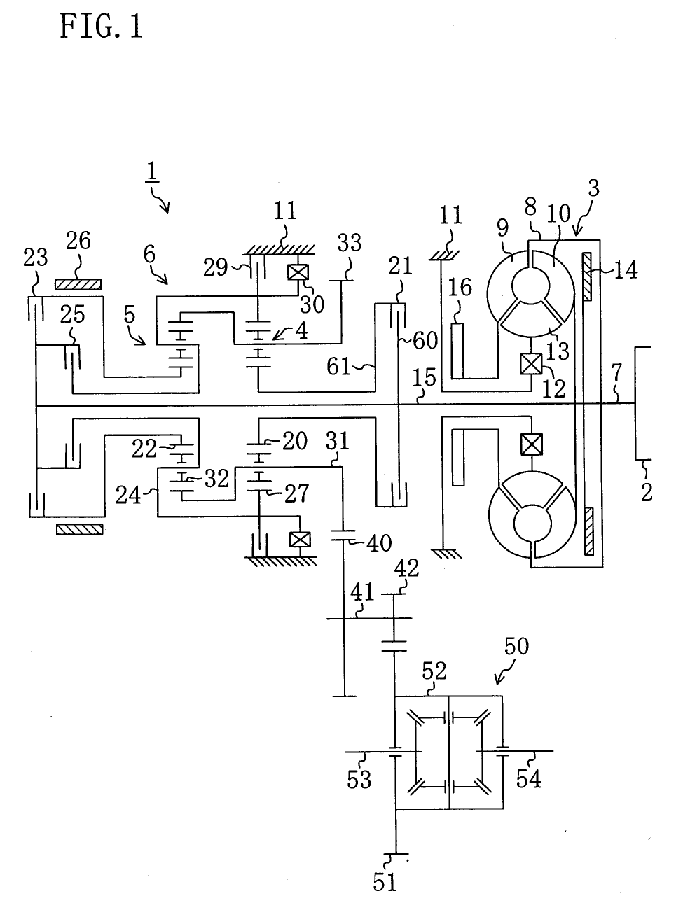

FIG. 1 shows a whole construction of an automatic transmission in accordance with the embodiment of the present invention. As shown in FIG. 1, the automatic transmission 1 includes a torque converter 3 to which the output of an engine 2 is input and a transmission gear mechanism 6 including first and second planetary gears (planetary gear mechanisms) 4, 5.

The torque converter 3 includes an impeller pump 9, a turbine runner 10, a stator 13, and a lockup clutch 14. The impeller pump 9 is fixed within a converter casing 8 connected to an engine output shaft 7. The turbine runner 10 is arranged so as to face the impeller pump 9 and is driven by operation oil from the impeller pump 9. The stator 13 is arranged between the impeller pump 9 and the turbine runner 10 and is supported by a transmission casing 11 through a one-way clutch 12. The lockup clutch 14 is arranged between the converter casing 8 and the turbine runner 10 for directly connecting the engine output shaft 7 to the turbine runner 10.

The output of the engine 2 is input from the engine output shaft 7 to the torque converter 3, is converted to torque, and is then output to the transmission gear mechanism 6 via a turbine shaft 15 serving as an input shaft. An oil pump 16 is arranged on the opposite side of the torque converter 3 to the engine 2 and is driven by the engine output shaft 7 via the converter casing 8 and the impeller pump 9.

The transmission gear mechanism 6 includes a forward clutch 21 as a multiple-disc clutch between the turbine shaft 15 and a sun gear 20 of the first planetary gear 4. A reverse clutch 23 is provided between the turbine shaft 15 and a sun gear 22 of the second planetary gear 5. Between the turbine shaft 15 and a pinion carrier 24 of the second planetary gear 5, there are provided a 3-4 clutch 25 and a 2-4 brake 26 fixing the sun gear 22 of the secondary planet gear 5. A ring gear 27 of the first planetary gear 4 is connected to the pinion carrier 24 of the second planetary gear 5. Between them and the transmission casing 11, a low reverse brake 29 and a one-way clutch 30 are arranged in parallel with each other. A pinion carrier 31 of the first planetary gear 4 is connected to a ring gear 32 of the second planetary gear 5, and an output gear 33 are connected to them as an output section.

An intermediate transmission mechanism is formed of a combination of a first intermediate gear 40 engaging all the time with the output gear 33, an idle shaft 41 having an end to which the first intermediate gear 40 is fixed, and a second intermediate gear 42 fixed to the other end of the idle shaft 41. The second intermediate gear 42 engages with an input gear 51 of a differential unit 50 so that the output of the transmission gear mechanism 6 is transmitted to the differential unit 50 via a differential casing 52 and then to left and right drive shafts 53, 54.

Table 1 indicates relationships between the transmission stages and the operation states of the respective friction elements 21, 23, 25, 26, 29 and the one-way clutch 30.

TABLE 1

| | | | 3-4 | 2-4 | Low | |
|---|---|---|---|---|---|---|
| | Forward | Reverse | clutch | brake | reverse | One-way |
| | clutch 21 | clutch 23 | 25 | 26 | brake 29 | clutch 30 |
| First | X | | | | (X) | X |
| Second | X | | | X | | |
| Third | X | | X | | | |
| Fourth | | | X | X | | |
| Reverse | | X | | | X | |

(X): operation only at low range

Detailed description will be given next to the forward clutch 21 and the vicinity thereof, which presents the significant feature of the present invention.

The automatic transmission 1 includes a first rotary member 60 connected to the turbine shaft 15 serving as the input shaft, a second rotary member 61 connected to the output gear 33, and the forward clutch 21 which connects/disconnects the first rotary member 60 to/from the second rotary member 61.

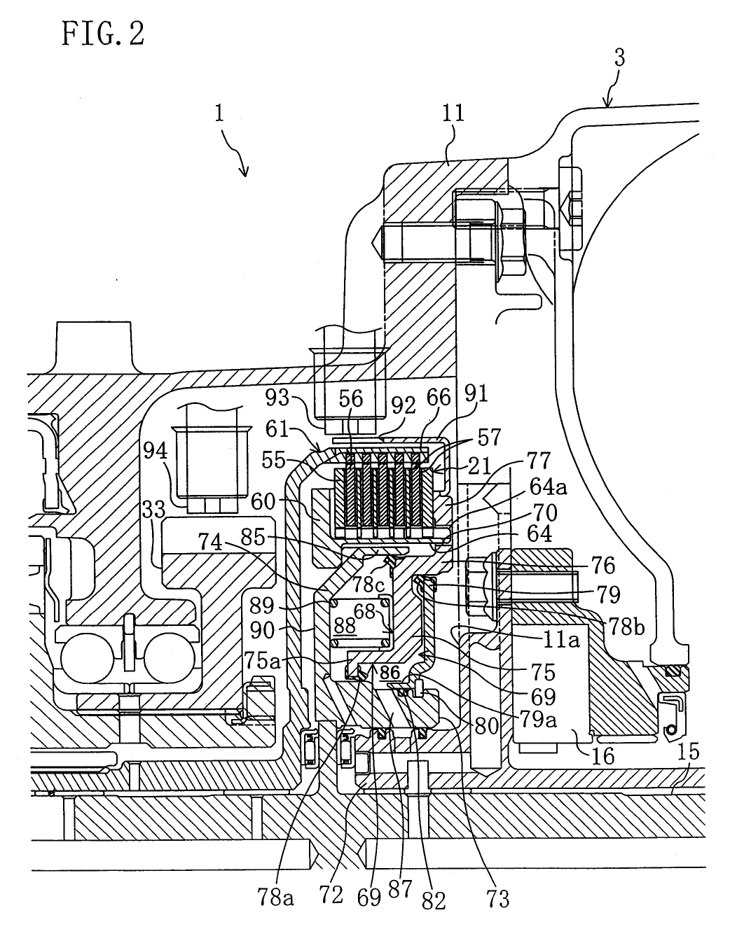

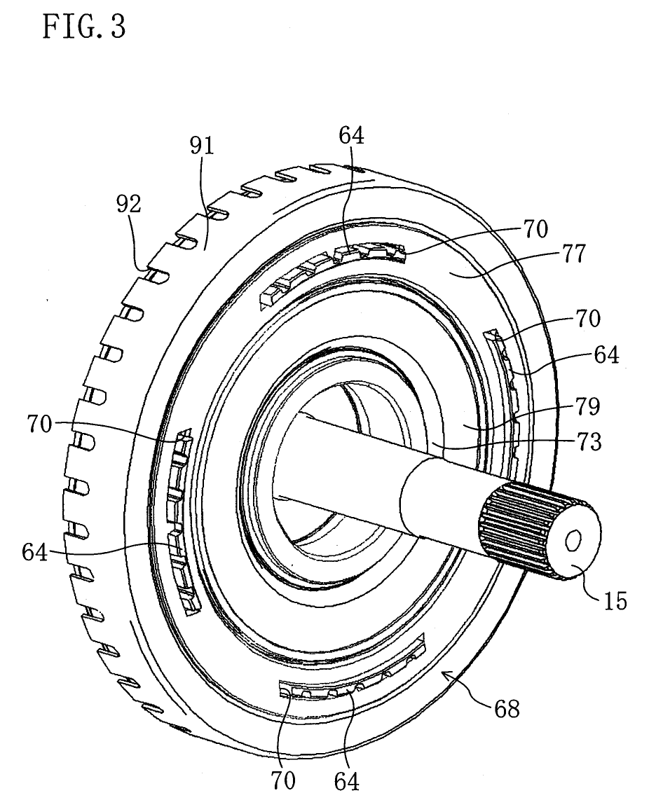

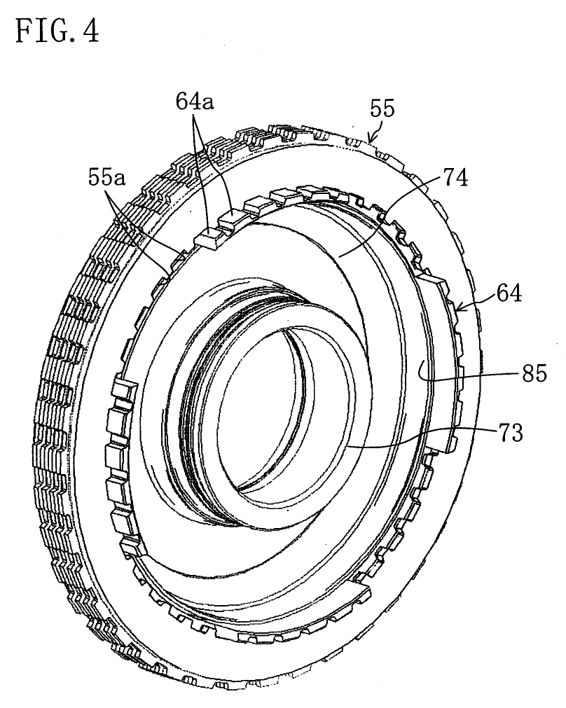

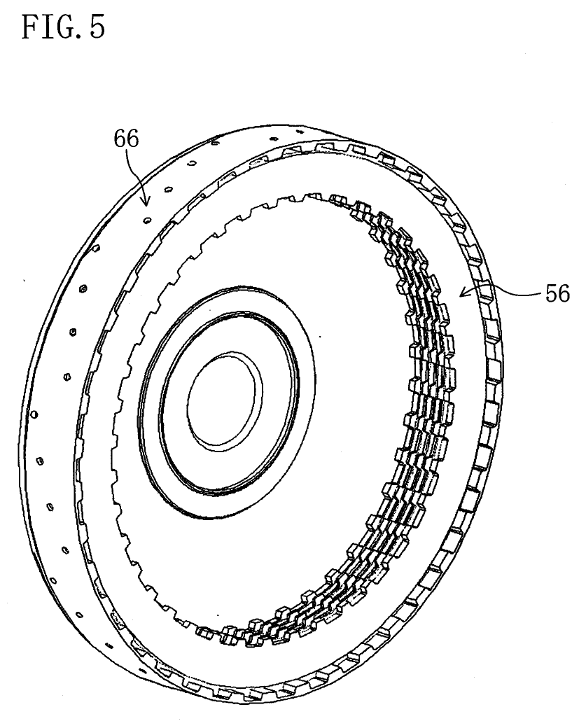

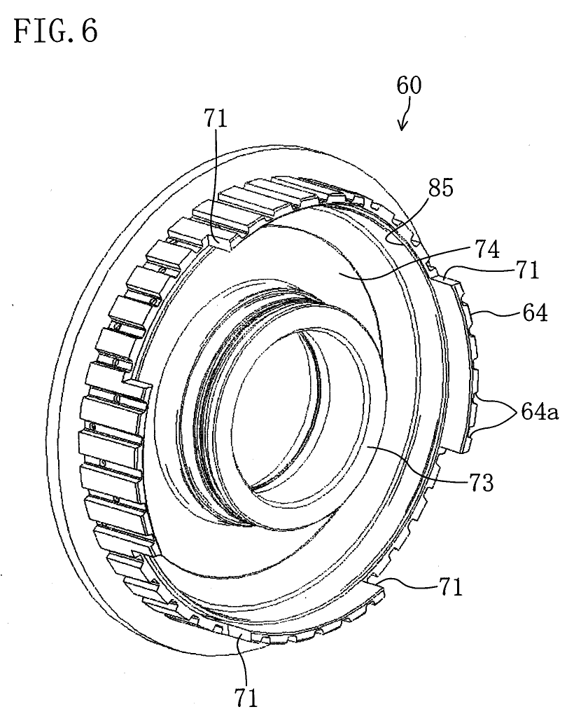

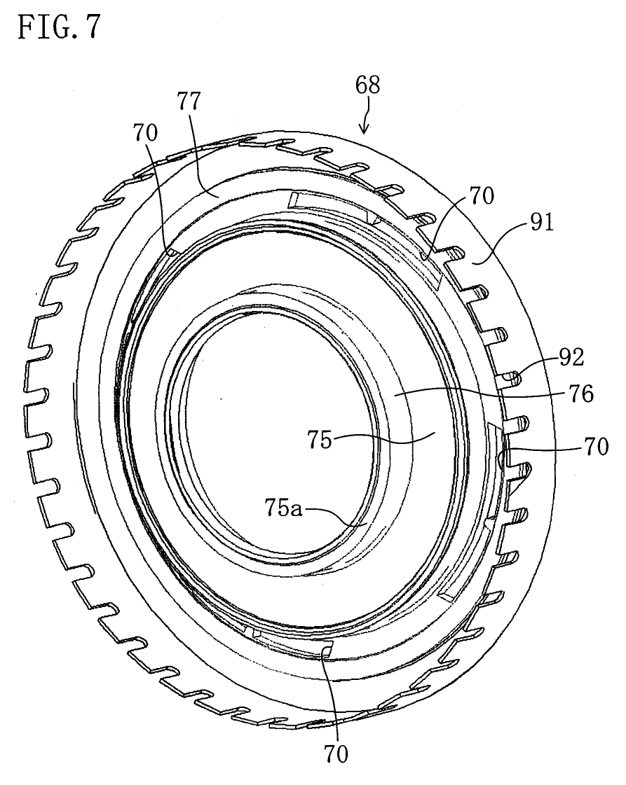

FIG. 2 is a sectional view in an enlarged scale showing the forward clutch 21 and the vicinity thereof. FIG. 3 shows the forward clutch 21 and members therearound. FIG. 4 shows hub side clutch discs to which a hub is fitted. FIG. 5 shows drum side clutch discs to which a drum is fitted. FIG. 6 and FIG. 7 show the hub and a piston, respectively.

As shown in FIG. 2, the forward clutch 21 includes at the inner periphery thereof a plurality of hub side clutch discs 55 while including at the outer periphery thereof a plurality of drum side clutch discs 56. A friction member 57 is attached to each face of the hub side clutch discs 55 except each outer face of the hub side clutch discs 55 on the respective sides. On the other hand, no friction member is attached to the drum side clutch discs 56. The friction members 57 are provided to only the hub side clutch discs 55 connected to the turbine shaft 15 for reducing drag torque by repulsion. The hub side clutch discs 55 on the respective sides are formed thicker than those arranged therebetween for preventing them from falling down.

A boss 72 which extends in the axial direction of the turbine shaft 15 away from the engine 2 and through which the turbine shaft 15 is inserted is formed at the axial center of a transmission casing side wall 11a serving as a side wall on the engine 2 side of the transmission casing 11. The first rotary member 60 is fitted rotatably to the boss 72. The first rotary member 60 is formed of, as shown in FIG. 6, a combination of a hub 64, a sleeve 73 rotatably fitted to the boss 72, and a first annular part 74 connecting the hub 64 and the sleeve 73. The hub 64 includes an outer periphery in which projections and depressions as a hub side clutch fitting part 64a are formed correspondingly to the hub side clutch discs 55. As shown in FIG. 4, the hub side clutch discs 55 are connected at the inner peripheries thereof to the hub 64 integrally rotatably. Specifically, a clutch side fitting part 55a is formed in the inner peripheries of the hub side clutch discs 55 so as to engage with the hub side clutch fitting part 64a. The hub side clutch discs 55 are supported at the outer peripheral face of the hub 64. A plurality (four in the present embodiment) of hub side notched portions 71 is formed at parts of the hub 64 with space left in the peripheral direction. A fourth annular portion 85 is formed at the inner periphery of the hub 64 so as to extend cylindrically toward the transmission casing side wall 11a coaxially with the hub 64.

In the forward clutch 21, the drum side clutch discs 56 are connected at the outer peripheries thereof to a drum 66 integrally rotatably in such a fashion that respective projections and depressions of both of them engage with each other, as shown in FIG. 5. In other words, the drum side clutch 56 is supported at the inner peripheral face of the drum 66.

As shown in FIG. 2, a piston 68 for pushing the forward clutch 21 is provided on the transmission casing side wall 11a side of the hub 64. The piston 68 includes a first lip sealing 78a at an inner peripheral part 75a thereof which slides on the sleeve 73 and a second annular portion 75 radially extending from the inner peripheral part 75a thereof. As also shown in FIG. 7, the piston 68 includes a cylindrical portion 76 connected to the outer peripheral part of the second annular portion 75 and extending toward the transmission casing side wall 11a. A third annular portion 77 extends radially from the end on the transmission casing side wall 11a side of the cylindrical portion 76.

A plurality (four in the present embodiment) of piston side notched portions 70 are formed in parts of the third annular portion 77 of the piston 68 so as to be displaced from the hub side notched portions 71 of the hub 64 in the peripheral direction. With the notched portions 70, 71 formed, parts of the hub 64 where the hub side notched portions 71 are not formed can be inserted into the piston side notched portions 70 of the piston 68, as shown in FIG. 3. The piston 68, which is compacted, can be easily arranged on the transmission casing side wall 11a side of the hub 64. The hub 64 and the piston 68 are arranged compactly in such a fashion that they are overlapped with each other in the axial direction by inserting the parts of one of the hub 64 and the piston 68 where no notched portions are formed into the notched portions 70 or 71 of the other, resulting in reduction in length of the automatic transmission 1 in the axial direction.

A hydraulic servo 69 for controlling the piston 68 is arranged inside the hub 64. Specifically, a sealing plate 79 is provided at the outer periphery of the sleeve 73 and includes an inner peripheral part 79a caught immovably toward the transmission casing side wall 11a by an annular stopper plate 80. An O ring 82 is provided between the inner peripheral part 79a of the sealing plate 79 and the outer periphery of the sleeve 73 for preventing oil leakage while a second lip sealing 78b is provided at the outer periphery of the radially outwardly extending sealing plate 79 so as to slide on the inner periphery of the cylindrical portion 76.

The piston 68 forms a pressure chamber 86 in a region which is surrounded by the sleeve 73, the second annular portion 75, the cylindrical portion 76, and the sealing plate 79 and which is prevented from oil leakage by the first and second lip sealings 78a, 78b and the O ring 82. Formation of the pressure chamber 86 inside the hub 64 reduces the size of the hydraulic servo 69. To the pressure chamber 86, high-pressure oil from the oil pump 16 is supplied through a high-pressure oil supply path 87 formed in the boss 72 and the sleeve 73. The hub 64 is connected through the first annular portion 74 to the sleeve 73 rotatably fitted to the boss 72 extending from the transmission casing 11, so that the operation oil pressurized in the oil pump 16 can be supplied through the boss 72 to the hydraulic servo 69. This eliminates the need to provide an additional high-pressure oil supply path, shortening the length in the axial direction of the automatic transmission 1.

A third lip sealing 78c provided at the outer periphery of the second annular portion 75 slides on the inner peripheral face of the fourth annular portion 85. The piston 68 forms a balancing chamber 88 in a region which is surrounded by the sleeve 73, the first annular portion 74, the fourth annular portion 85, and the second annular portion 75 and is prevented from oil leakage by the first and third two lip sealings 78. Within the balancing chamber 88, a plurality of return springs 89 are arranged in the peripheral direction for pushing the second annular portion 75 of the piston 68 toward the transmission casing side wall 11a. Thus, the first annular portion 74 and the fourth annular portion 85, which serve in combination as a joint member between the hub 64 and the sleeve 73, also serve as a sealing plate of the balancing chamber 88, achieving further size reduction of the hydraulic servo 69.

In the first annular portion 74, an operation oil supply guide 90 is formed for supplying the operation oil to the hub 64 from the opposite side of the first annular portion 74 to the piston 68. Namely, though the arrangement of the piston 68 inside the hub 64 necessitates supply of the operation oil to the hub 64 from the opposite side to the piston 68, an additional operation oil supply path therefor is unnecessary because the operation oil supply guide 90 formed in the first annular portion 74 guides and supplies the operation oil to the hub 64.

As shown in FIG. 2, an input side rotation sensor 93 for detecting the rotation of the hub 64 is provided at the exterior of the drum 66. The input side rotation sensor 93 is composed of a proximity sensor, for example.

As shown in FIG. 3 and FIG. 7, an extended portion 91 is formed at the outer peripheral end of the piston 68 on the side open to the drum 66 (the transmission casing side wall 11a side) so as to extend radially from the outer peripheral end thereof and extend further in the axial direction between the input side rotation sensor 93 and the drum 66. The extended portion 91 forms notches 92 open to the output gear 33 side equally. The notches 92 are located below the input side rotation sensor 93 to function as a sensing rotor as a to-be-detected part at which the input side rotation sensor 93 detects the rotation of the hub 64. Thus, the input side rotation sensor 93 detects the notches 92 of the piston 68 to detect the number of rotation of the turbine shaft 15.

Further, as shown in FIG. 2, an output side rotation sensor 94 composed of a proximity sensor is provided at the exterior of the output gear 33 for detecting the number of rotation of the output gear 33 as an output.

Accurate detection of the respective numbers of rotations of the turbine shaft 15 and the output gear 33 by the input side rotation sensor 93 and the output side rotation sensor 94 enables speed change at appropriate timing, improving the shift quality.

### Effects of the Embodiment

Hence, in the automatic transmission in accordance with the present embodiment, the hydraulic servo 69 is provided inside the hub 64 connected to the turbine shaft 15 so that the piston 68 and the hub 64 rotate integrally with each other. This eliminates the need to create clearance for contact prevention between the piston 68 and the hub 64. As described above, when the plurality of notched portions 70, 71 are formed in the piston 68 and the hub 64, respectively, with their position displaced from each other in the peripheral direction and the parts of the hub 64 where the hub side notched portions 71 are not formed are inserted into the piston side notched portions 70 of the piston 68, the piston 68 and the hub 64 are overlapped with each other in the axial direction. This shortens the length in the axial direction of the turbine shaft 15 to reduce the size of the automatic transmission 1.

As described above, the hub 64 is provided inside the drum 66 to be covered with drum 66, thereby disabling direct detection of the number of rotation of the hub 64. While, the piston 68 and the hydraulic servo 69 are provided inside the hub 64 connected to the turbine shaft 15 so that the piston 68 and the hub 64 rotate integrally with each other. Accordingly, when the notches 92 as the to-be-detected part for the input side rotation sensor 93 is formed in the piston 68, the input side rotation sensor 93 provided at the exterior of the drum 66 can detects the number of rotation of the hub 64 through the notches 92, resulting in effective detection of the rotation of the piston 68 provided inside the hub 64 to achieve space-saving.

It should be noted that the above embodiment is substantially a mare preferred example and does not intend to limit the present invention and applicable subjects and use thereof.

What is claimed is:

1. An automatic transmission comprising:
an input shaft;
an output section;
a first rotary member connected to the input shaft;
a second rotary member connected to the output section;
a multiple-disc clutch that connects/disconnects the first rotary member to/from the second rotary member;
a hub provided inside the multiple-disc clutch;
a drum provided around the multiple-disc clutch;
a piston which pushes the multiple-disc clutch; and
a hydraulic servo that controls the piston, the hydraulic servo being provided at the hub or a member connected to the hub,
wherein a plurality of notched portions are formed in the piston and the hub with positions thereof displaced from each other in a peripheral direction, and
the piston and the hub are overlapped with each other in an axial direction in such a fashion that parts of one of the piston and the hub where no notched portions are formed are inserted into the notched portions of the other.

2. The automatic transmission of claim 1, further comprising:
a transmission casing surrounding the automatic transmission and including a transmission casing side wall; and
a boss which extends in the axial direction from an axial center of the transmission casing side wall and through which the input shaft is inserted,
wherein the first rotary member includes:
the hub;
a sleeve rotatably fitted to the boss; and
a first annular portion connecting the hub and the sleeve.

3. The automatic transmission of claim 2,
wherein the piston includes:
a second annular portion having an inner peripheral part sliding on an outer periphery of the sleeve and extending radially outwardly;
a cylindrical portion connected to an outer periphery of the second annular portion and extending toward the transmission casing side wall; and
a third annular portion connected to an end part on the transmission casing side wall side of the cylindrical portion and extending in a radial direction.

4. The automatic transmission of claim 2, further comprising:
a sealing plate which includes an inner peripheral part caught immovably toward the transmission casing side wall by the outer periphery of the sleeve and which extends radially outwardly so as to slide at an outer periphery thereof on an inner periphery of the cylindrical portion,
wherein the piston forms a pressure chamber in a region surrounded by the sleeve, the second annular portion, the cylindrical portion, and the sealing plate.

5. The automatic transmission of claim 4,
wherein the hub includes a fourth annular portion cylindrically extending toward the transmission casing side wall,
the second annular portion incudes an outer peripheral part sliding on an inner peripheral face of the fourth annular portion, and
the piston forms a balancing chamber in a region surrounded by the sleeve, the first annular portion, the fourth annular portion, and the second annular portion.

6. The automatic transmission of claim 2,
wherein an operation oil supply guide is formed in the first annular portion for supplying operation oil to the hub from an opposite side of the first annular portion to the piston.

7. The automatic transmission of claim 1, further comprising:
a rotation sensor which detects rotation of the hub, the rotation sensor being provided at an exterior of the drum,
wherein the piston and the hydraulic servo are provided at the hub or a member connected to the hub, and
a to-be-detected part at which the rotation sensor detects the rotation thereof is provided at the piston.

8. The automatic transmission of claim 7,
wherein the to-be-detected part for the rotation sensor extends radially from an outer peripheral end of the piston on a side open to the drum and further extends in the axial direction between the rotation sensor and the drum.

9. The automatic transmission of claim 7,
wherein the hub is connected to the input section.

10. The automatic transmission of claim 7,
wherein the piston includes:
a second annular portion having an inner peripheral part sliding on an outer periphery of the sleeve and extending radially outwardly;
a cylindrical portion connected to an outer peripheral part of the second annular portion and extending toward the transmission casing side wall; and
a third annular portion connected to an end part on the transmission casing side wall side of the cylindrical portion and extending in the radial direction,
the automatic transmission further comprising:
a transmission casing which includes a transmission casing side wall and through which the input shaft is inserted;
a boss which extends in the axial direction from an axial center of the transmission casing side wall and through which the input shaft is inserted;
a sleeve rotatably fitted to the boss;
a first annular portion connecting the hub and the sleeve; and
a sealing plate which includes an inner peripheral part caught immovably toward the transmission casing side wall by an outer periphery of the sleeve and which extends outwardly radially so as to slide at an outer periphery thereof on an inner periphery of the cylindrical portion,
wherein the piston forms a pressure chamber in a region surrounded by the sleeve, the second annular portion, the cylindrical portion, and the sealing plate.

11. The automatic transmission of claim 10,
wherein the hub includes a fourth annular portion cylindrically extending toward the transmission casing side wall,
the second annular portion includes an outer peripheral part sliding on an inner peripheral face of the fourth annular portion, and
the piston forms a balancing chamber in a region surrounded by the sleeve, the first annular portion, the fourth annular portion, and the second annular portion.
